(19) United States
(12) Patent Application Publication
(10) Pub. No.: US 2017/0310969 A1
(43) Pub. Date: Oct. 26, 2017

(54) IMAGE ENCODING METHOD AND APPARATUS WITH COLOR SPACE TRANSFORM PERFORMED UPON PREDICTOR AND ASSOCIATED IMAGE DECODING METHOD AND APPARATUS

(71) Applicant: MEDIATEK INC., Hsin-Chu (TW)

(72) Inventors: Li-Heng Chen, Tainan City (TW); Tung-Hsing Wu, Chiayi City (TW); Han-Liang Chou, Hsinchu County (TW)

(21) Appl. No.: 15/480,394

(22) Filed: Apr. 6, 2017

Related U.S. Application Data
(60) Provisional application No. 62/324,995, filed on Apr. 20, 2016.

(51) Int. Cl. H04N 19/136; H04N 19/186; H04N 19/12; H04N 19/182; H04N 19/70; H04N 19/61

(52) U.S. Cl. CPC H04N 19/136; H04N 19/70; H04N 19/61; H04N 19/12; H04N 19/182; H04N 19/186

(57) ABSTRACT

An image encoding method for encoding an image includes following steps: determining a coding mode selected from a plurality of candidate coding modes for a current coding block, wherein the current coding block included in the image comprises a plurality of pixels; and encoding the current coding block into a part of a bitstream according to at least the determined coding mode. The step of encoding the current coding includes: determining a first predictor presented in a first color space according to a plurality of reconstructed pixels presented in the first color space; transforming the first predictor presented in the first color space to a second predictor presented in a second color space different from the first color space; and encoding the current coding block under the second color space according to at least the second predictor.

### CROSS REFERENCE TO RELATED APPLICATIONS

This application claims the benefit of U.S. provisional application No. 62/324,995, filed on Apr. 20, 2016 and incorporated herein by reference.

### BACKGROUND

The disclosed embodiments of the present invention relate to image encoding and image decoding, and more particularly, to image encoding method and apparatus with color space transform performed upon a predictor and associated image decoding method and apparatus.

A display interface is disposed between a first chip and a second chip to transmit display data from the first chip to the second chip for further processing. For example, the first chip may be a host application processor (AP), and the second chip may be a driver integrated circuit (IC). When a display panel supports a higher display resolution, 2D/3D display with higher resolution can be realized. Hence, the display data transmitted over the display interface would have a larger data size/data rate, which increases the power consumption of the display interface inevitably. If the host application processor and the driver IC are both located at the same portable device (e.g., smartphone) powered by a battery device, the battery life is shortened due to the increased power consumption of the display interface. Thus, there is a need for a data compression design which can effectively reduce the data size/data rate of the display data transmitted over the display interface as well as the power consumption of the display interface.

### SUMMARY

In accordance with exemplary embodiments of the present invention, image encoding method and apparatus with color space transform performed upon a predictor and associated image decoding method and apparatus are proposed.

According to a first aspect of the present invention, an exemplary image encoding method for encoding an image is disclosed. The exemplary image encoding method includes: determining a coding mode selected from a plurality of candidate coding modes for a current coding block, wherein the current coding block included in the image comprises a plurality of pixels; and encoding the current coding block into apart of a bitstream according to at least the determined coding mode. The step of encoding the current coding block includes: determining a first predictor presented in a first color space according to a plurality of reconstructed pixels presented in the first color space; transforming the first predictor presented in the first color space to a second predictor presented in a second color space, wherein the second color space is different from the first color space; and encoding the current coding block under the second color space according to at least the second predictor.

According to a second aspect of the present invention, an exemplary image decoding method for decoding a bitstream generated from encoding an image is disclosed. exemplary image decoding method includes: deriving a second color space and a coding mode used for encoding a current coding block in the image from the bitstream, wherein the current coding block included in the image comprises a plurality of pixels; and decoding the current coding block into a part of a decoded image according to at least the derived coding mode. The step of decoding the current coding block includes: determining a first predictor presented in a first color space according to a plurality of reconstructed pixels presented in the first color space, wherein the first color space is different from the second color space; transforming the first predictor presented in the first color space to a second predictor presented in the second color space; and decoding the current coding block under the second color space according to at least the second predictor.

According to a third aspect of the present invention, an exemplary image encoder for encoding an image is disclosed. The exemplary image encoder includes a mode decision circuit and a compression circuit. The mode decision circuit is configured to determine a coding mode selected from a plurality of candidate coding modes for a current coding block, wherein the current coding block included in the image comprises a plurality of pixels. The compression circuit is configured to encode the current coding block into a part of a bitstream according to at least the determined coding mode, wherein the compression circuit determines a first predictor presented in a first color space according to a plurality of reconstructed pixels presented in the first color space, transforms the first predictor presented in the first color space to a second predictor presented in a second color space, and encodes the current coding block under the second color space according to at least the second predictor, where the second color space is different from the first color space.

According to a fourth aspect of the present invention, an exemplary image decoder for decoding a bitstream generated from encoding an image is disclosed. The exemplary image decoder includes an entropy decoding circuit and a processing circuit. The entropy decoding circuit is configured to derive a second color space and a coding mode used for encoding a current coding block in the image from the bitstream, wherein the current coding block included in the image comprises a plurality of pixels. The processing circuit is configured to decode the current coding block into apart of a decoded image according to at least the derived coding mode, wherein the processing circuit determines a first predictor presented in a first color space according to a plurality of reconstructed pixels presented in the first color space, transforms the first predictor presented in the first color space to a second predictor presented in the second color space, and decodes the current coding block under the second color space according to at least the second predictor, where the first color space is different from the second color space.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image encoder according to an embodiment of the present invention.

FIG. 2 is a flowchart illustrating a first encoding operation according to an embodiment of the present invention.

FIG. 3 is a diagram illustrating a previous pixel line used for midpoint value computation of a current coding block according to an embodiment of the present invention.

FIG. 4 is a diagram illustrating a previous coding block used for midpoint value computation of a current coding block according to an embodiment of the present invention.

FIG. 5 is a flowchart illustrating an MPP-mode encoding procedure according to an embodiment of the present invention.

FIG. 6 is a diagram illustrating an example of generating mean values of Y channel, Co channel and Cg channel of a coding block in the YCoCg color space according to an embodiment of the present invention.

FIG. 7 is a diagram illustrating syntax elements of a coding block according to an embodiment of the present invention.

FIG. 8 is a flowchart illustrating a second encoding operation according to an embodiment of the present invention.

FIG. 9 is a diagram illustrating another example of generating mean values of Y channel, Co channel and Cg channel of a coding block in the YCoCg color space according to an embodiment of the present invention.

FIG. 10 is a flowchart illustrating an MPPF-mode encoding procedure according to an embodiment of the present invention.

FIG. 11 is a block diagram illustrating an image decoder according to an embodiment of the present invention.

FIG. 12 is a flowchart illustrating an MPP-mode/MPPF-mode decoding procedure according to an embodiment of the present invention.

FIG. 13 is a flowchart illustrating a first predictor computation scheme employed by the processing circuit of the image decoder according to an embodiment of the present invention.

FIG. 14 is a flowchart illustrating a second predictor computation scheme employed by the processing circuit of the image decoder according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

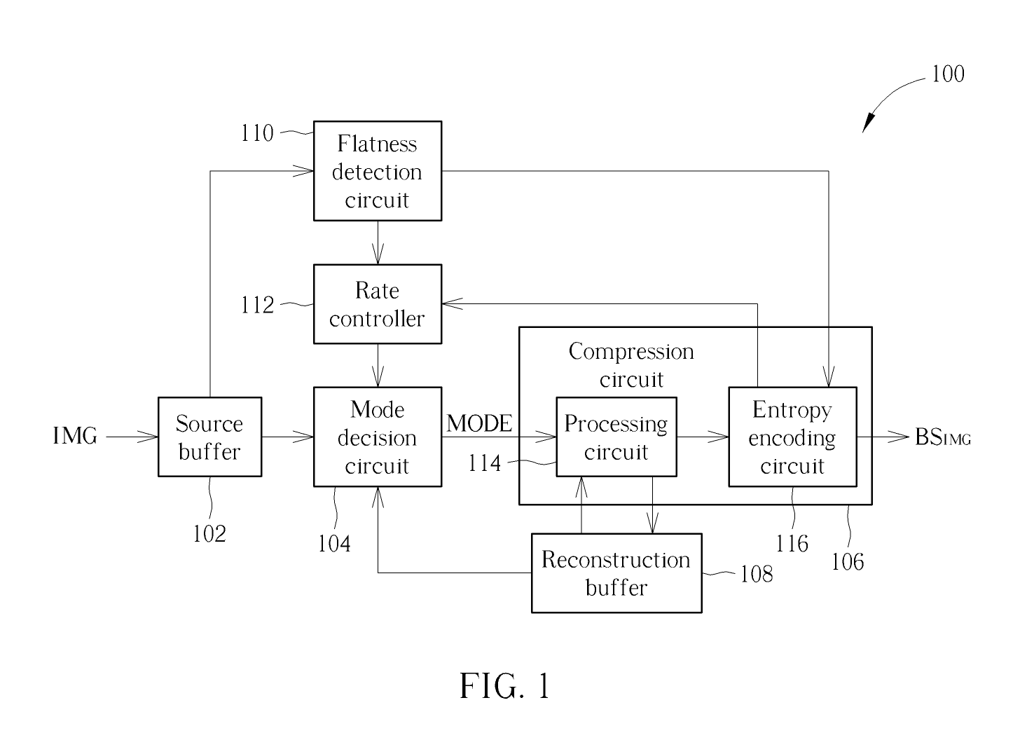

FIG. 1 is a block diagram illustrating an image encoder according to an embodiment of the present invention. In this embodiment, the image encoder 100 may be a Video Electronics Standards Association (VESA) Advanced Display Stream Compression (A-DSC) encoder. However, this is for illustrative purposes only, and is not meant to be a limitation of the present invention. In practice, any image encoder using the proposed color-transformed predictor to calculate residuals of pixels of a coding block (or called coding unit) falls within the scope of the present invention. The image encoder 100 is used to encode/compress a source image IMG into a bitstream BS_{IMG}. In this embodiment, the image encoder 100 includes a source buffer 102, a mode decision circuit 104, a compression circuit 106, a reconstruction buffer 108, a flatness detection circuit 110, and a rate controller 112. The compression circuit 106 includes a processing circuit 114 and an entropy encoding circuit 116, where the processing circuit 114 is configured to perform several encoding functions, including prediction, quantization, reconstruction, etc. The source buffer 102 is configured to buffer pixel data of the source image IMG to be encoded/compressed. The flatness detection circuit 110 is configured to detect a transition from a non-flat area of the source image IMG to a flat area of the source image IMG. Specifically, the flatness detection circuit 110 classifies each coding block to one of different flatness types based on the complexity estimation of previous, current and next coding blocks, where the flatness type affects the rate-control mechanism. Hence, the flatness detection circuit 110 generates a quantization parameter (QP) adjustment signal to the rate controller 112, and also outputs flatness indication to the entropy encoding circuit 116, such that the flatness type of each coding block is explicitly signaled to an image decoder though the bitstream BS_{IMG}. The rate controller 112 is configured to adaptively control the quantization parameter, such that the image quality can be maximized while a desired bit rate is ensured.

The source image IMG may be divided into a plurality of slices, wherein each of the slices may be independently encoded. In addition, each of the slices may have a plurality of coding blocks (or called coding units), each having a plurality of pixels. Each coding block (coding unit) is a basic compression unit. For example, each coding block (coding unit) may have 8×2 pixels according to VESA A-DSC, where 8 is the width of the coding block (coding unit), and 2 is the height of the coding block (coding unit). The mode decision circuit 104 is configured to determine a coding mode (e.g., best mode) MODE selected from a plurality of candidate coding modes for a current coding block (e.g., an 8×2 block) to be encoded. In accordance with VESA A-DSC, the candidate coding modes may be categorized into regular modes (e.g., transform mode, block prediction mode, pattern mode, delta pulse code modulation (DPCM) mode, and mid-point prediction (MPP) mode) and fallback modes (e.g., mid-point prediction fallback (MPPF) mode and “Blocker Predictor (BP) Skip” mode). A rate-distortion optimization (RDO) mechanism is employed by the mode decision circuit 104 to select a coding mode with a smallest rate-distortion cost (R-D cost) as the best mode MODE for encoding the current coding block. In addition, the mode decision circuit 104 informs the processing circuit 114 of the best mode MODE.

When the best mode is an MPP mode or an MPPF mode, a predictor is calculated by the processing circuit 114, residuals of the current coding block are calculated by the processing circuit 114 through subtracting the predictor from each pixel of the current coding block (i.e., residual_{8×2}=source pixel_{8×2}−predictor), and the residuals of the current coding block are quantized by the processing circuit 114 through a quantizer.

The MPP mode uses the midpoint value (MP) as the predictor. The residuals of MPP mode are quantized by a simple power-of-2 quantizer. For each pixel, the k last significant bits are removed after the quantization process, where k is calculated by the quantization parameter (QP). The quantization process of MPP mode may be represented using the following formula.

$${RES}_{quantized} = \{ \begin{matrix}( res + round ) >> k , res > 0 \\ - ( ( round - res ) >> k ) , res \leq 0\end{matrix} \qquad ( 1 )$$

In above formula (1), the term “RES_{quantized}” represents the quantized residual, the term “res” represents the residual, and the term “round” represents the rounding value.

The MPPF mode is designed to guarantee the precise rate-control mechanism. Same as the MPP mode, the MPPF mode uses the midpoint value (MP) as the predictor. The residuals of MPPF mode are quantized by a one-bit quantizer. In other words, the quantized residuals are encoded using 1 bit per color channel sample. Hence, the quantized residuals of the current coding block (e.g., 8×2 block) have 48 bits, that is, 16 pixels*(1 bit/color channel)*(3 color channels/pixel).

When the best mode is an MPP mode or an MPPF mode, the processing circuit 114 outputs quantized residuals of the current coding block to the entropy encoding circuit 116. The entropy encoding circuit 116 encodes the quantized residuals of the current coding block into a part of the bitstream BS_{IMG}.

The reconstruction buffer 108 is configured to store reconstructed pixels of some or all coding blocks in the source image IMG. For example, the processing circuit 114 performs inverse quantization upon the quantized residuals of the current coding block to generate inverse quantized residuals of the current coding block, and then adds the predictor to each of the inverse quantized residuals to generate one corresponding reconstructed pixel of the current coding block. Neighboring reconstructed pixels of the current coding block to be encoded may be read from the reconstruction buffer 108 for computing the predictor for the current coding block encoded using the MPP/MPPF mode.

An improvement on the MPP mode is proposed. Specifically, an MPP mode with color-space RDO may be employed to encode a coding block in one of a plurality of color spaces (e.g., RGB color space and YCoCg color space). To determine which of the RGB color space and YCoCg color space is selected for encoding a coding block under the improved MPP mode (i.e., MPP mode with color-space RDO), a predictor presented in the RGB color space and a predictor presented in the YCoCg color space are both needed to be calculated.

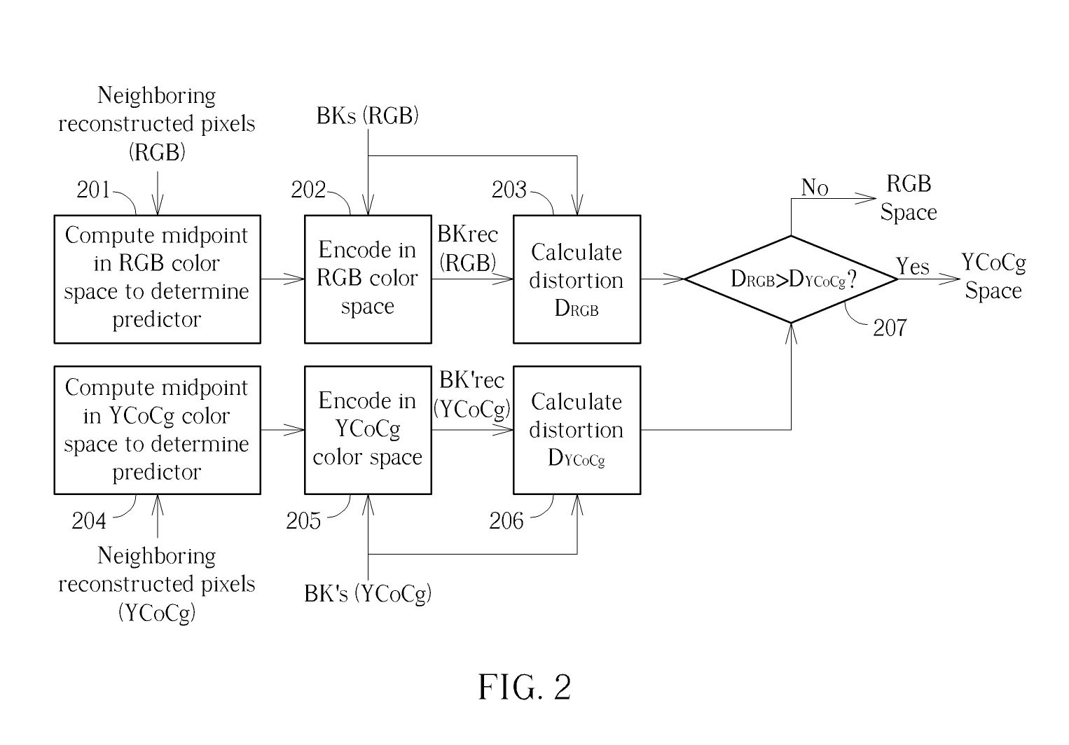

FIG. 2 is a flowchart illustrating a first encoding operation according to an embodiment of the present invention. The first encoding operation shown in FIG. 2 may be performed by the compression circuit 106 shown in FIG. 1. At step 201, a midpoint value in the RGB color space is computed to determine a predictor in the RGB space for a current coding block. The midpoint value is set by a fixed value (if neighboring reconstructed pixels needed for midpoint value computation of a current coding block are not available), or is computed from neighboring reconstructed pixels (if neighboring reconstructed pixels needed for midpoint value computation of the current coding block are available).

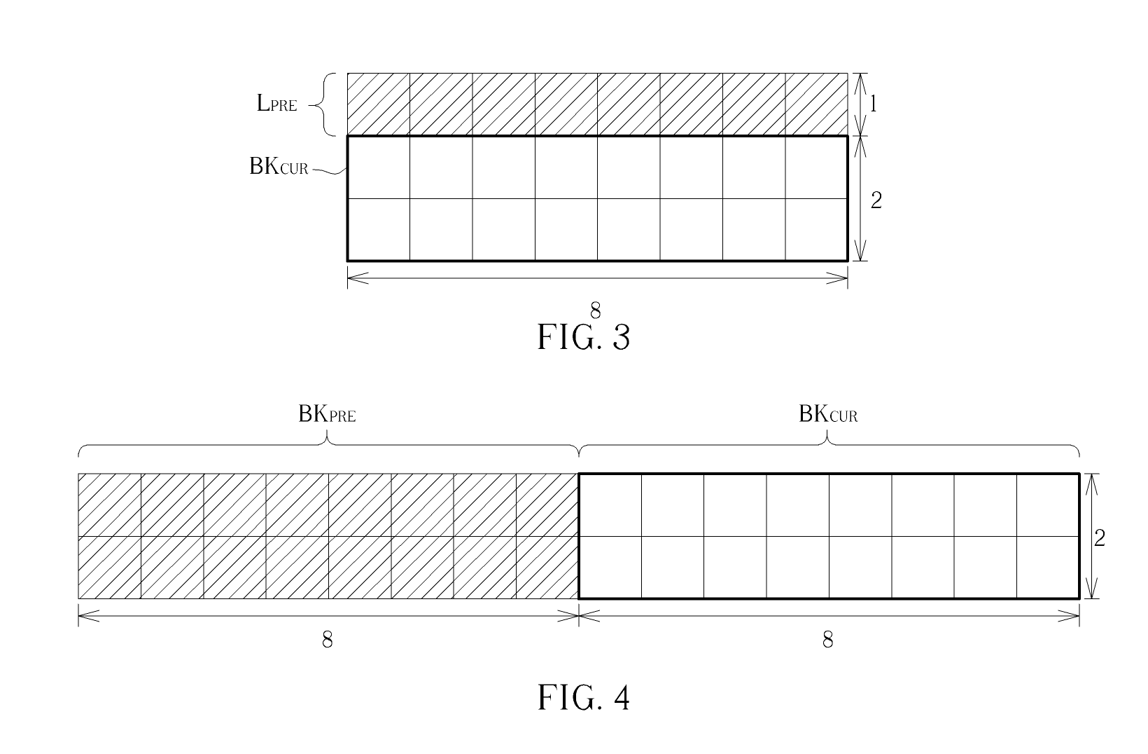

In a first exemplary design, neighboring reconstructed pixels needed for midpoint value computation of a current coding block are located at a previous pixel line, as illustrated in FIG. 3. The current coding block BK_{CUR} is an 8×2 block composed of 16 pixels, where 8 is the width of the current coding block BK_{CUR}, and 2 is the height of the current coding block BK_{CUR}. If the current coding block BK_{CUR} is a non-first-row block in the source image IMG, reconstructed pixels can be generated from reconstructing a plurality of pixels of a previous pixel line L_{PRE}, where the previous pixel line L_{PRE} is directly above an upper-most pixel line of the current coding block BK_{CUR}. Suppose that the reconstructed pixels are presented in the RGB color space. For each color channel (R, G, or B) of the RGB color space, a mean value (MP′_{R}, MP′_{G}, or MP′_{B}) of the reconstructed pixels of the previous pixel line L_{PRE} is calculated to act an initial predictor value in the color channel. In one exemplary design, an initial predictor composed of mean values (MP′_{R}, MP′_{G}, MP′_{B}) presented in the RGB color domain may be directly used as a final predictor used for encoding the current coding block BK_{CUR}. Hence, a predictor (MP_{R}, MP_{G}, MP_{B}) of the current coding block BK_{CUR} is set by (MP′_{R}, MP′_{G}, MP′_{B}) obtained in the RGB color space. In an alternative design, a processing function (e.g., clipping, rounding, and/or adding a value that may be calculated according to QP) may be performed upon each mean value (MP′_{R}, MP′_{G}, or MP′_{B}) in one color channel (R, G, or B) of the RGB color space to generate a processed mean value (e.g., clipped/rounded/value-added mean value) as a final predictor value (MP_{R}, MP_{G}, or MP_{B}) in the color channel. Hence, a predictor of the current coding block BK_{CUR} is set by (MP_{R}, MP_{G}, MP_{B}) presented in the RGB color space.

However, if the current coding block BK_{CUR} is the first-row block in the source image IMG, this means reconstructed pixels at the previous pixel line L_{PRE} do not exist. Hence, a half value of the dynamic range of input pixels is directly used as a predictor of the current coding block BK_{CUR}. For an 8-bit input source, the predictor (MP_{R}, MP_{G}, MP_{B}) of the current coding block BK_{CUR} is set by (128, 128, 128). For a 10-bit input source, the predictor (MP_{R}, MP_{G}, MP_{B}) of the current coding block BK_{CUR} is set by (512, 512, 512).

In a second exemplary design, neighboring reconstructed pixels needed for midpoint value computation of a current coding block are located at a previous coding block, as illustrated in FIG. 4. The current coding block BK_{CUR} is an 8×2 block composed of 16 pixels, where 8 is the width of the current coding block BK_{CUR}, and 2 is the height of the current coding block BK_{CUR}. If the current coding block BK_{CUR} is not the first-column block in the source image IMG, reconstructed pixels can be generated from reconstructing a plurality of pixels of a previous coding block BK_{PRE} (which is also an 8×2 block composed of 16 pixels, where 8 is the width of the previous coding block BK_{PRE}, and 2 is the height of the previous coding block BK_{PRE}). The previous coding block BK_{PRE} is a left coding block of the current coding block BK_{CUR}. Suppose that the reconstructed pixels are presented in the RGB color space. For each color channel (R, G, or B) of the RGB color space, a mean value (MP′_{R}, MP′_{G}, or MP′_{B}) of the reconstructed pixels of the previous coding block BK_{PRE} is calculated to act an initial predictor value in the color channel. In one exemplary design, an initial predictor composed of mean values (MP′_{R}, MP′_{G}, MP′_{B}) presented in the RGB color domain may be directly used as a final predictor used for encoding the current coding block BK_{CUR}. Hence, a predictor (MP_{R}, MP_{G}, MP_{B}) of the current coding block BK_{CUR} is set by (MP′_{R}, MP′_{G}, MP′_{B}) obtained in the RGB color space. In an alternative design, a processing function (e.g., clipping, rounding and/or adding a value that may be calculated according to QP) may be performed upon each mean value (MP′_{R}, MP′_{G}, or MP′_{B}) in one color channel (R, G, or B) of the RGB color space to generate a processed mean value (e.g., clipped/rounded/value-added mean value) as a final predictor value (MP_{R}, MP_{G}, or MP_{B}) in the color channel. Hence, a predictor of the current coding block BK_{CUR} is set by (MP_{R}, MP_{G}, MP_{B}) obtained in the RGB color space.

However, if the current coding block BK_{CUR} is the first-column block in the source image IMG, this means reconstructed pixels at the previous coding block BK_{PRE} do not exist. Hence, a half value of the dynamic range of input pixels is directly used as a predictor of the current coding block BK_{CUR}. For an 8-bit input source, the predictor (MP_{R}, MP_{G}, MP_{B}) of the current coding block BK_{CUR} is set by (128, 128, 128). For a 10-bit input source, the predictor (MP_{R}, MP_{G}, MP_{B}) of the current coding block BK_{CUR} is set by (512, 512, 512).

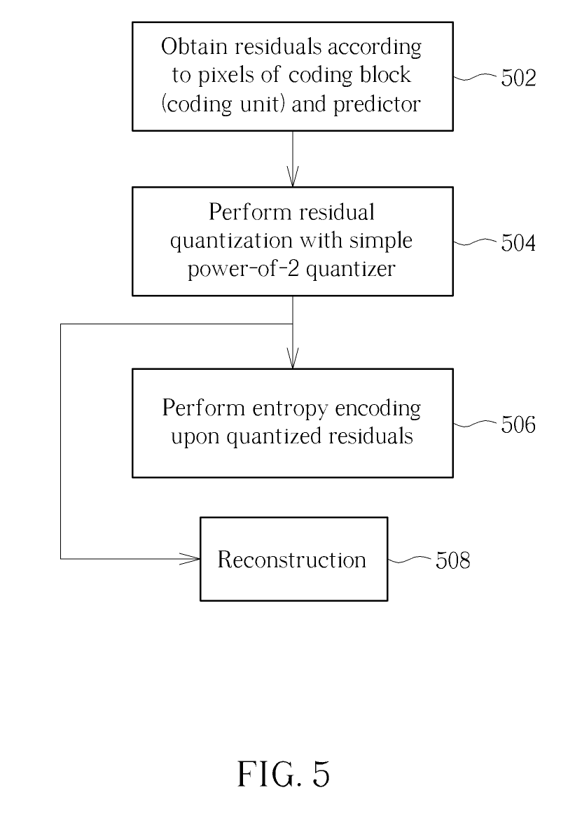

After the MPP mode predictor in the RGB color domain is computed, step 202 is performed to encode pixels of the current coding block in the RGB color space. FIG. 5 is a flowchart illustrating an MPP-mode encoding procedure according to an embodiment of the present invention. Step 202 may be implemented using the flow shown in FIG. 5. At step 502, the processing circuit 114 obtains residuals (e.g., residual_{8×2}) according to pixels of the current coding block (e.g., source pixel_{8×2}) and the predictor (e.g., predictor=(MP_{R}, MP_{G}, MP_{B})). For example, residual_{8×2}=source pixel_{8×2}−predictor. At step 504, the processing circuit 114 performs residual quantization with a simple power-of-2 quantizer. Hence, quantized residuals presented in the RGB color space are generated. At step 506, the entropy encoding circuit 116 performs entropy encoding upon the quantized residuals presented in the RGB color space. In addition, at step 508, the processing circuit 114 performs a reconstruction procedure according to the quantized residuals, and generates a reconstructed coding block BK_{rec} presented in the RGB color space accordingly.

At step 203, the processing circuit 114 calculates distortion D_{RGB} between the source coding block BK_{S} (i.e., current coding block to be encoded) presented in the RGB color space and the reconstructed coding block BK_{rec} also presented in the RGB color space.

As mentioned above, to determine which of the RGB color space and YCoCg color space is selected for encoding a coding block under the improved MPP mode (i.e., MPP mode with color-space RDO), a predictor presented in the RGB color space and a predictor presented in the YCoCg color space are both needed to be calculated. At step 204, a midpoint value in the YCoCg color space is computed to determine a predictor in the YCoCg color space for the same current coding block. The predictor computation in the RGB color space is similar to the predictor computation in the YCoCg color space. The midpoint value is set by a fixed value (if neighboring reconstructed pixels presented in YCoCg color space and needed for midpoint value computation of a current coding block are not available), or is computed from neighboring reconstructed pixels (if neighboring reconstructed pixels presented in YCoCg color space and needed for midpoint value computation of the current coding block are available).

At step 204, the neighboring reconstructed pixels needed for midpoint value computation of a current coding block may be located at a previous pixel line as illustrated in FIG. 3, or may be located at a previous coding block as illustrated in FIG. 4. Suppose that neighboring reconstructed pixels needed for computing the predictor presented YCoCg color space are available in the RGB color space. Hence, a color space transform operation may be performed to transform the neighboring reconstructed pixels presented in RGB color space into neighboring reconstructed pixels presented in the YCoCg color space. After the neighboring reconstructed pixels presented in the YCoCg color space are obtained, a predictor of the current coding block can be computed in the YCoCg color space according to the neighboring reconstructed pixels presented in the YCoCg color space.

For example, neighboring reconstructed pixels needed for midpoint value computation of a current coding block are located at a previous pixel line, as illustrated in FIG. 3. The current coding block BK_{CUR} is an 8×2 block composed of 16 pixels. If the current coding block BK_{CUR} is a non-first-row block in the source image IMG, reconstructed pixels of the previous pixel line L_{PRE} directly above an upper-most pixel line of the current coding block BK_{CUR} may be presented in the RGB color space and may be transformed to the YCoCg color space for computing a predictor in the YCoCg color space. For each color channel (Y, Co, or Cg) of the YCoCg color space, a mean value (MP′_{Y}, MP′_{Co}, or MP′_{Cg}) of the color-transformed reconstructed pixels of the previous pixel line L_{PRE} is calculated to act an initial predictor value in the color channel. In one exemplary design, an initial predictor composed of mean values (MP′_{Y}, MP′_{Co}, MP′_{Cg}) presented in the YCoCg color domain may be directly used as a final predictor used for encoding the current coding block BK_{CUR}. Hence, a predictor (MP_{Y}, MP_{Co}, MP_{Cg}) of the current coding block BK_{CUR} is set by (MP′_{Y}, MP′_{Co}, MP′_{Cg}) obtained in the YCoCg color space. In an alternative design, after the initial predictor value is computed according to the previous pixel line, a processing function (e.g., clipping, rounding, and/or adding a value that may be calculated according to QP) may be performed upon each mean value (MP′_{Y}, MP′_{Co}, or MP′_{Cg}) in one color channel (Y, Co, or Cg) of the YCoCg color space to generate a processed mean value (e.g., clipped/rounded/value-added mean value) as a final predictor value (MP_{Y}, MP_{Co}, or MP_{Cg}) in the color channel. Hence, a predictor of the current coding block BK_{CUR} is set by (MP_{Y}, MP_{Co}, MP_{Cg}) obtained in the YCoCg color space. However, if the current coding block BK_{CUR} is the first-row block in the source image IMG, this means reconstructed pixels at the previous pixel line L_{PRE} do not exist. Hence, a half value of the dynamic range of pixels in the YCoCg color domain is directly used as a predictor of the current coding block BK_{CUR}. For an 8-bit YCoCg format, the predictor (MP_{Y}, MP_{Co}, MP_{Cg}) of the current coding block BK_{CUR} is set by (128, 0, 0). For a 10-bit YCoCg format, the predictor (MP_{Y}, MP_{Co}, MP_{Cg}) of the current coding block BK_{CUR} is set by (512, 0, 0).

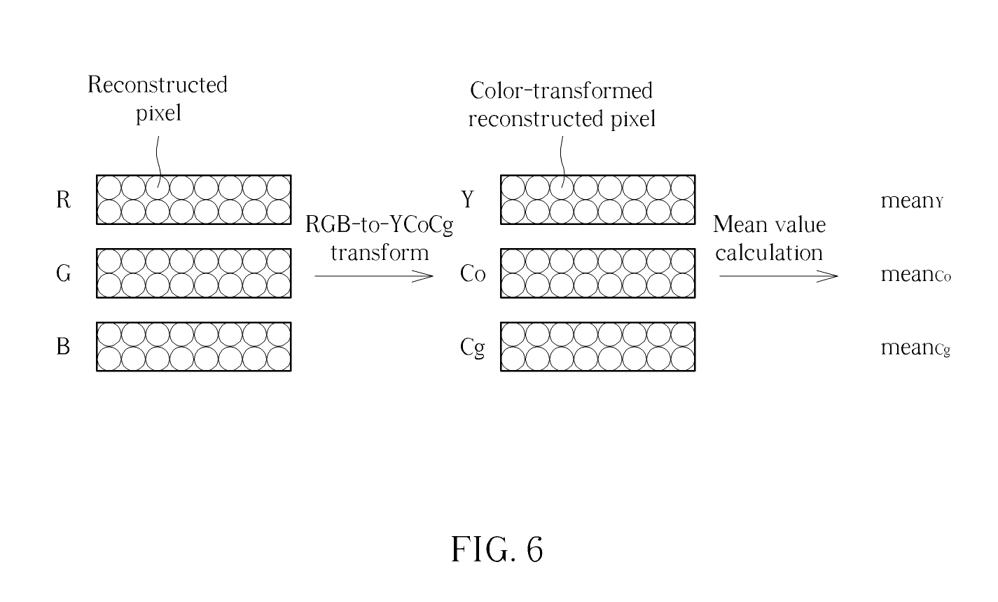

For another example, neighboring reconstructed pixels needed for midpoint value computation of a current coding block are located at a previous coding block, as illustrated in FIG. 4. The current coding block BK_{CUR} is an 8×2 block composed of 16 pixels. If the current coding block BK_{CUR} is a non-first-column block in the source image IMG, reconstructed pixels of the previous coding block BK_{PRE} (which is a left coding block of the current coding block BK_{CUR}) may be presented in the RGB color space and may be transformed to the YCoCg color space for computing a predictor in the YCoCg color space. For each color channel (Y, Co, or Cg) of the YCoCg color space, a mean value (MP′_{Y}, MP′_{Co}, or MP′_{Cg}) of the reconstructed pixels of the previous coding block BK_{PRE} is calculated to act an initial predictor value in the color channel. FIG. 6 is a diagram illustrating an example of generating mean values of Y channel, Co channel and Cg channel of a coding block in the YCoCg color space according to an embodiment of the present invention. As shown in FIG. 6, RGB-to-YCoCg transform is performed upon the reconstructed pixels, each having one R channel sample, one G channel sample and one B channel sample, to generate color-transformed reconstructed pixels, each having one Y channel sample, one Co channel sample and one Cg channel sample. For example, the following RGB-to-YCoCg transform matrix may be employed by the processing circuit 114.

$$[ \begin{matrix}Y \\ Co \\ Cg\end{matrix} ] = [ \begin{matrix}1 / 4 & 1 / 2 & 1 / 4 \\ 1 & 0 & - 1 \\ - 1 / 2 & 1 & - 1 / 2\end{matrix} ] [ \begin{matrix}R \\ G \\ B\end{matrix} ] \qquad ( 2 )$$

After the color-transformed reconstructed pixels of the 8×2 coding block are obtained, one mean value (denoted by mean_{Y}) is computed based on all Y channel samples of the 8×2 coding block, another mean value (denoted by mean_{Co}) is computed based on all Co channel samples of the 8×2 coding block, and yet another mean value (denoted by mean_{Cg}) is computed based on all Cg channel samples of the 8×2 coding block.

In one exemplary design, an initial predictor composed of mean values (MP′_{Y}, MP_{Co}, MP′_{Cg}) presented in the YCoCg color domain may be directly used as a final predictor used for encoding the current coding block BK_{CUR}. Hence, a predictor (MP_{Y}, MP_{Co}, MP_{Cg}) of the current coding block BK_{CUR} is set by (MP′_{Y}, MP_{Co}, MP′_{Cg}) obtained in the YCoCg color space. In an alternative design, after the initial predictor is computed based on the previous coding block, a processing function (e.g., clipping, rounding, and/or adding a value that may be calculated according to QP) may be performed upon each mean value (MP′_{Y}, MP′_{Co}, or MP′_{Cg}) in one color channel (Y, Co, or Cg) of the YCoCg color space to generate a processed mean value (e.g., clipped/rounded/value-added mean value) as a final predictor value (MP_{Y}, MP_{Co}, or MP_{Cg}) in the color channel. Hence, a predictor of the current coding block BK_{CUR} is set by (MP_{Y}, MP_{Co}, MP_{Cg}) obtained in the YCoCg color space. However, if the current coding block BK_{CUR} is the first-column block in the source image IMG, this means reconstructed pixels at the previous coding block BK_{PRE} do not exist. Hence, a half value of the dynamic range of pixels presented in the YCoCg color domain is directly used as a predictor of the current coding block BK_{CUR}.

After the MPP mode predictor in the YCoCg color domain is computed, step 205 is performed to encode pixels of the current coding block in the YCoCg color space. Step 205 may be implemented using the same flow shown in FIG. 5. Hence, concerning encoding of the current coding block in the YCoCg color space, the same flow shown in FIG. 5 may be performed to achieve residual quantization (steps 502 and 504) and entropy encoding (step 506), and may be performed to achieve reconstruction (step 508).

At step 206, the processing circuit 114 calculates distortion D_{YCoCg} between the source coding block BK′_{S} (i.e., current coding block to be encoded) presented in the YCoCg color space and the reconstructed coding block BK′_{rec} also presented in the YCoCg color space. For example, the source coding block BK′_{S} presented in the YCoCg color space may be obtained by applying RGB-to-YCoCg transform to the source coding block BK_{S} presented in the RGB color space.

At step 207, the processing circuit 114 performs color space determination by comparing distortion D_{RGB} with distortion D_{YCoCg}. When D_{RGB} is not larger than D_{YCoCg} (i.e., D_{RGB}≦D_{YCoCg}), the processing circuit 114 decides that the current coding block should be encoded using the MPP mode in the RGB color space. However, when D_{RGB} is larger than D_{YCoCg} (i.e., D_{RGB}>D_{YCoCg}), the processing circuit 114 decides that the current coding block should be encoded using the MPP mode in the YCoCg color space.

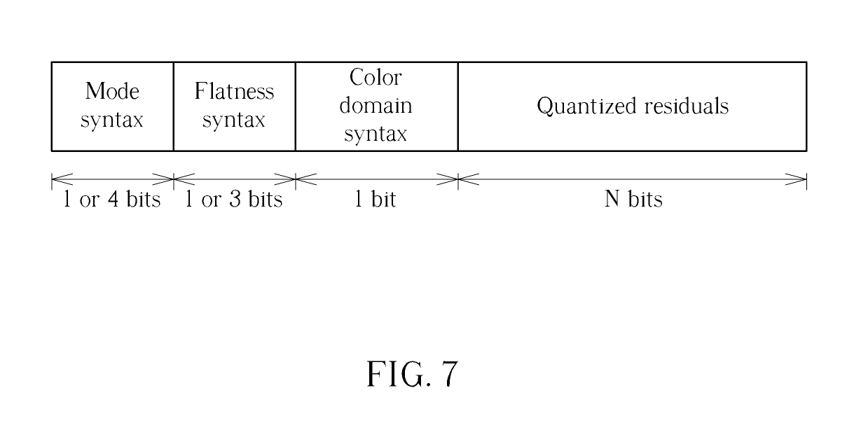

The selected MPP mode and color space associated with encoding of a current coding block are signaled to an image decoder through the bitstream BS_{IMG}. Hence, the image decoder can know the coding mode selected by the image encoder 100 to encode the current coding block is MPP mode, and can also know the selected color space in which the selected MPP mode is performed. FIG. 7 is a diagram illustrating syntax elements of a coding block (or called coding unit) according to an embodiment of the present invention. The mode syntax is set to signal the chosen coding mode (e.g., MPP mode) of a current coding block. The flatness syntax is set to signal the flatness type of the current coding block. The color domain syntax is set to signal the color space (e.g., RGB color space or YCoCg color space) used for encoding the current coding block. The quantized residuals of the MPP mode are used to signal the processed quantized residuals. The syntax elements of the current coding block, including control information (e.g., mode, flatness and color domain) and quantized residuals, may be entropy encoded by the entropy encoding circuit 116.

In above example, it is assumed that the neighboring reconstructed pixels are originally available in the RGB color space. Hence, RGB-to-YCoCg transform is performed upon the reconstructed pixels presented in the RGB color space to obtain the reconstructed pixels presented in the YCoCg color space that are needed to compute a predictor presented in the YCoCg color space. However, this is not meant to be a limitation of the present invention. Alternatively, the neighboring reconstructed pixels may be originally available in the YCoCg color space. Hence, YCoCg-to-RGB transform may be performed upon the reconstructed pixels presented in the YCoCg color space to obtain the reconstructed pixels presented in the RGB color space that are needed to compute a predictor presented in the RGB color space. For example, the following YCoCg-to-RGB transform matrix may be employed by the processing circuit 114.

$$[ \begin{matrix}R \\ G \\ B\end{matrix} ] = [ \begin{matrix}1 & 1 / 2 & - 1 / 2 \\ 1 & 0 & 1 / 2 \\ 1 & - 1 / 2 & - 1 / 2\end{matrix} ] [ \begin{matrix}Y \\ Co \\ Cg\end{matrix} ] \qquad ( 3 )$$

In a case where the neighboring reconstructed pixels are originally available in the RGB color space and the current coding block has 8×2 pixels, the derivation of one predictor presented in RGB color space may require one mean calculation, and the derivation of one predictor presented in YCoCg color space may require 16 color transform operations and one mean calculation. Hence, the computational complexity of one predictor presented in RGB color space and one predictor presented in YCoCg color space may include 16 color transform operations and 2 mean calculations. In another case where the neighboring reconstructed pixels are originally available in the YCoCg color space and the current coding block has 8×2 pixels, the derivation of one predictor presented in YCoCg color space may require one mean calculation, and the derivation of one predictor presented in RGB color space may require 16 color transform operations and one mean calculation. Hence, the computational complexity of one predictor presented in RGB color space and one predictor presented in YCoCg color space may include 16 color transform operations and 2 mean calculations.

To reduce the computational complexity of one predictor presented in RGB color space and one predictor presented in YCoCg color space, the present invention therefore proposes a new predictor computation scheme which apply color space transform to a predictor presented in a first color space to generate a predictor presented in a second color space different from the first color space. For example, one of the first color space and the second color space may be an RGB color space, and the other of the first color space and the second color space may be a YCoCg color space.

In one exemplary design, the predictor presented in the first color space may be composed of mean values, such as (MP′_{R}, MP′_{Co}, MP′_{Cg}) for RGB color space or (MP′_{Y}, MP′_{Co}, MP′_{Cg}) for YCoCg color space. Hence, the color-transformed predictor presented in the second color space is composed of color-transformed mean values, and may be directly used as a final predictor for encoding a coding block. Alternatively, the color-transformed predictor presented in the second color space may be an initial predictor. A processing function (e.g., clipping, rounding, and/or adding a value that may be calculated according to QP) may be performed upon color-transformed mean values of the initial predictor to generate processed color-transformed mean value (e.g., clipped/rounded/value-added color-transformed mean values) as predictor values of a final predictor used for encoding a coding block.

In another exemplary design, the predictor presented in the first color space may be composed of processed mean values (e.g., clipped/rounded/value-added mean values). Hence, the color-transformed predictor presented in the second color space is composed of color-transformed processed mean values (e.g., color-transformed clipped/rounded/value-added mean values), and may be directly used as a final predictor for encoding a coding block.

In summary, no matter whether a predictor to be transformed from a first color space to a second color space is composed of mean values or is composed of processed mean values (e.g., clipped/rounded/value-added mean values), using a color-transformed predictor to indirectly/directly set a final predictor used for encoding a coding block in the second color space would fall within the scope of the present invention. Further details of the proposed predictor computation scheme are described as below.

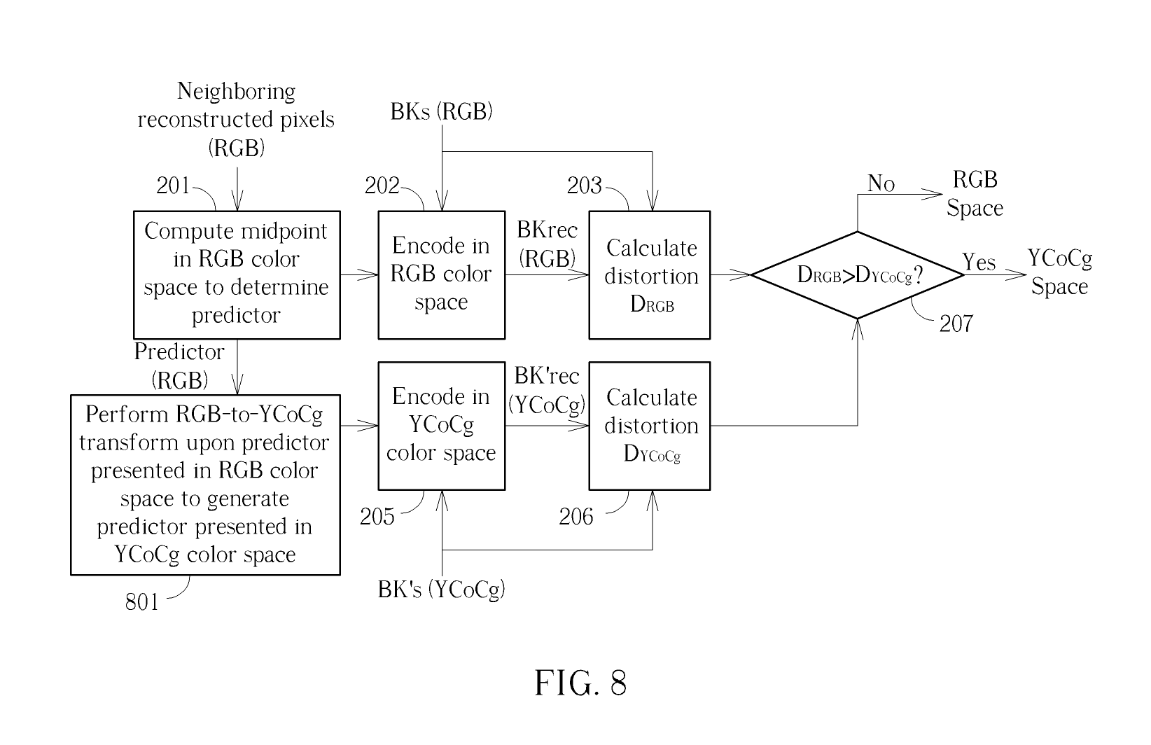

FIG. 8 is a flowchart illustrating a second encoding operation according to an embodiment of the present invention. The second encoding operation shown in FIG. 8 may be performed by the compression circuit 106 shown in FIG. 1. The major difference between the second encoding operation shown in FIG. 8 and the first encoding operation shown in FIG. 2 is that step 204 is replaced with step 801. When the current coding block BK_{CUR} is a non-first-row block as illustrated in FIG. 3, a predictor presented in the RGB color space can be computed based on neighboring reconstructed pixels that are presented in the RGB color space and located at the previous pixel line L_{PRE}. Alternatively, when the current coding block BK_{CUR} is a non-first-column block as illustrated in FIG. 4, a predictor presented in the RGB color space can be computed based on neighboring reconstructed pixels that are presented in the RGB color space and located at the previous coding block BK_{PRE}. The predictor (MP_{R}, MP_{G}, MP_{B}) obtained in step 201 can be used to obtain a predictor (MP_{Y}, MP_{Co}, MP_{Cg}) presented in the YCoCg color space. For example, the predictor (MP_{R}, MP_{G}, MP_{B}) may be composed of means values or may be composed of processed mean values (e.g., clipped/rounded/value-added means values), depending upon actual design considerations. At step 801, the processing circuit 114 performs RGB-to-YCoCg transform upon the predictor (MP_{R}, MP_{G}, MP_{B}) presented in the RGB color space to generate the predictor (MP_{Y}, MP_{Co}, MP_{Cg}) presented in the YCoCg color space. For example, a final predictor used for encoding a coding block in the YCoCg color space may be directly set by the color-transformed predictor (MP_{Y}, MP_{Co}, MP_{Cg}), or may be indirectly derived from applying a processing function (e.g., clipping, rounding, and/or adding a value that may be calculated according to QP) to the color-transformed predictor (MP_{Y}, MP_{Co}, MP_{Cg}).

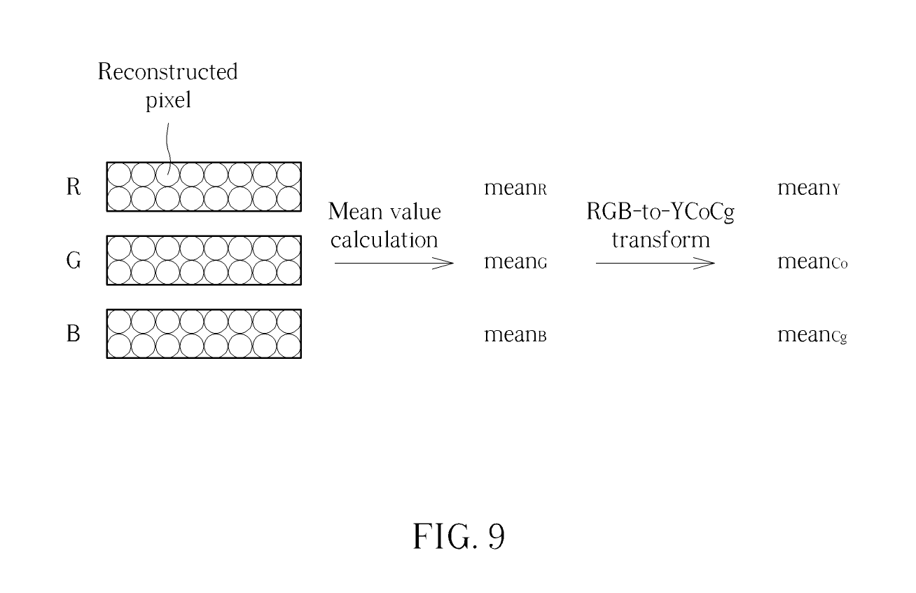

FIG. 9 is a diagram illustrating another example of generating mean values of Y channel, Co channel and Cg channel of a coding block in the YCoCg color space according to an embodiment of the present invention. As shown in FIG. 9, reconstructed pixels, each having one R channel sample, one G channel sample and one B channel sample, are processed to calculate mean values (denoted by mean_{R}, mean_{G}, and mean_{B}) of R channel, G channel and B channel of a coding block in the RGB color space, respectively. Supposing that a predictor in the RGB color space is set by mean values (mean_{R}, mean_{G}, mean_{B}), RGB-to-YCoCg transform is performed upon the predictor presented in the RGB color space to generate a color-transformed predictor, having mean values (denoted by mean_{Y}, mean_{Co}, and mean_{Cg}) of Y channel, Co channel and Cg channel of the coding block in the YCoCg color space, respectively. For example, the aforementioned RGB-to-YCoCg transform matrix in formula (2) may be employed by the processing circuit 114 to transfer a predictor from an RGB color space to a YCoCg color space.

In above example, it is assumed that the neighboring reconstructed pixels are originally available in the RGB color space. Hence, RGB-to-YCoCg transform is performed upon the predictor presented in the RGB color space to obtain the predictor presented in the YCoCg color space. However, this is not meant to be a limitation of the present invention. Alternatively, the neighboring reconstructed pixels may be originally available in the YCoCg color space. Hence, YCoCg-to-RGB transform may be performed upon the predictor presented in the YCoCg color space to obtain the predictor presented in the RGB color space. For example, the aforementioned YCoCg-to-RGB transform matrix in formula (3) may be employed by the processing circuit 114 transfer a predictor from the YCoCg color space to an RGB color space.

In a case where the neighboring reconstructed pixels are originally available in the RGB color space and the current coding block has 8×2 pixels, the derivation of one predictor presented in RGB color space may require one mean calculation, and the derivation of one predictor presented in YCoCg color space may require one color transform operation. Hence, the computational complexity of one predictor presented in RGB color space and one predictor presented in YCoCg color space may include one mean operation and one color transform calculation. In another case where the neighboring reconstructed pixels are originally available in the YCoCg color space and the current coding block has 8×2 pixels, the derivation of one predictor presented in YCoCg color space may require one mean calculation, and the derivation of one predictor presented in RGB color space may require one color transform operation. Hence, the computational complexity of one predictor presented in YCoCg color space and one predictor presented in RGB color space may include one mean operation and one color transform calculation. Compared to the predictor computation scheme used in the first encoding operation shown in FIG. 2, the predictor computation scheme used in the second encoding operation shown in FIG. 8 has lower computational complexity.

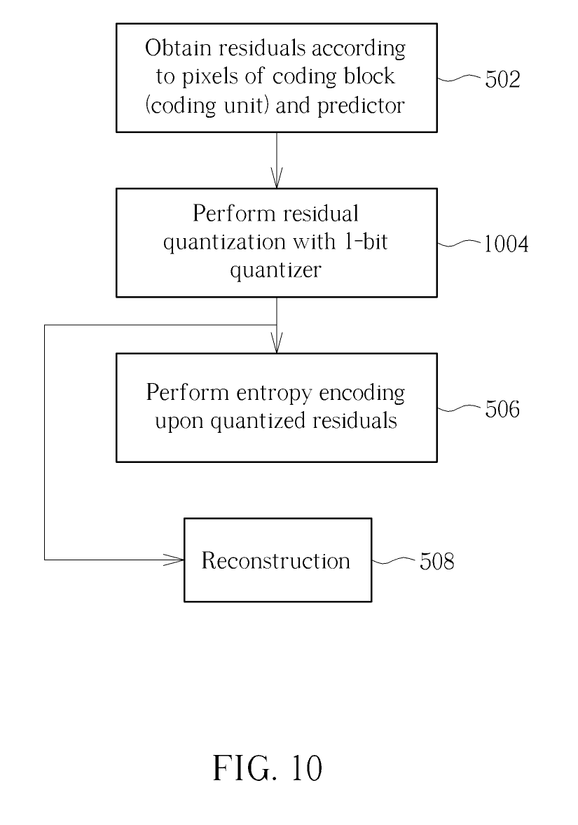

Like the MPP mode, the MPPF mode also uses the midpoint value to determine a predictor used for calculating residuals of a coding block. Hence, the proposed predictor computation scheme can also be employed in the MPPF mode. For example, when the coding mode (e.g., best mode) MODE selected by the mode decision circuit 104 is the MPPF mode, the compression circuit 106 may perform the first encoding operation as shown in FIG. 2, where each of steps 202 and 205 performed under improved MPPF mode (i.e., MPPF mode with color-space RDO) may be implemented using the flow shown in FIG. 10. FIG. 10 is a flowchart illustrating an MPPF-mode encoding procedure according to an embodiment of the present invention. The major difference between the MPPF-mode encoding procedure shown in FIG. 10 and the MPP-mode encoding procedure shown in FIG. 5 is that residuals of MPPF mode are quantized by a one-bit quantizer (Step 1004), such that MPPF-mode quantized residual is encoded using one bit per color channel.

When the first encoding operation under improved MPPF mode (i.e., MPPF mode with color-space RDO) is employed, the computational complexity of one predictor presented in RGB color space and one predictor presented in YCoCg color space may include 16 color transform operations and 2 mean calculations. To reduce the computational complexity of one predictor presented in RGB color space and one predictor presented in YCoCg color space, the compression circuit 106 may perform the second encoding operation as shown in FIG. 8, where each of steps 202 and 205 performed under improved MPPF mode (i.e., MPPF mode with color-space RDO) may be implemented using the flow shown in FIG. 10. When the second encoding operation under improved MPPF mode (i.e., MPPF mode with color-space RDO) is employed, the computational complexity of one predictor presented in RGB color space and one predictor presented in YCoCg color space may include one color transform operation and one mean calculation.

The selected MPPF mode and color space associated with encoding of a current coding block are signaled to an image decoder through the bitstream BS_{IMG}. Hence, the image decoder can know the coding mode selected by the image encoder 100 to encode the current coding block is MPPF mode, and can also know the selected color space in which the MPPF mode is performed. Similarly, the syntax elements shown in FIG. 7 may be used to signal the chosen coding mode (e.g., MPPF mode) of a current coding block, the flatness type of the current coding block, the color space (e.g., RGB color space or YCoCg color space) used for encoding the current coding block, and processed quantized residuals of the MPPF mode.

As mentioned above, the chosen coding mode (e.g., MPP mode or MPPF mode) of a current coding block and the color space (e.g., RGB color space or YCoCg color space) used for encoding the current coding block are signaled to an image decoder through the bitstream IMG_{BS}. After deriving the chosen coding mode (e.g., MPP mode or MPPF mode) of a current coding block and the color space (e.g., RGB color space or YCoCg color space) used for encoding the current coding block from the bitstream IMG_{BS}, the image decoder itself needs to compute a predictor used by the chosen coding mode (e.g., MPP mode or MPPF mode) in the color space (e.g., RGB color space or YCoCg color space) for decoding/reconstructing pixels in the coding block due to that fact that the predictor computed and used by the image encoder is not signaled to the image decoder through the bitstream BS_{IMG}. The aforementioned predictor computation scheme employed by the image encoder 100 may also be employed by the image decoder. Further details are described as below.

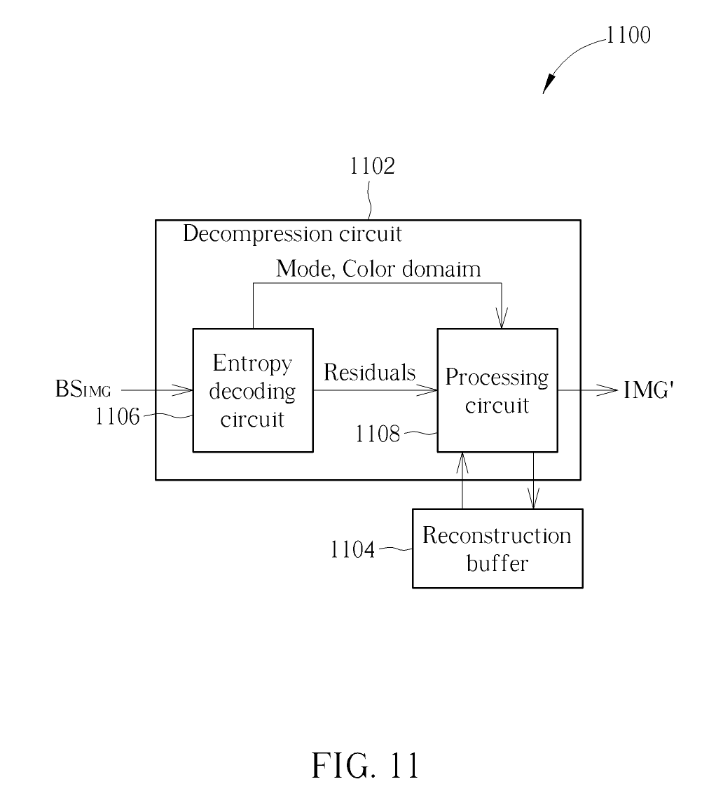

FIG. 11 is a block diagram illustrating an image decoder according to an embodiment of the present invention. In this embodiment, the image decoder 1100 may be a Video Electronics Standards Association (VESA) Advanced Display Stream Compression (A-DSC) decoder. However, this is for illustrative purposes only, and is not meant to be a limitation of the present invention. In practice, any image decoder using the proposed color-transformed predictor for calculation of residuals of pixel data falls within the scope of the present invention. The image decoder 1100 is used to decode/decompress a bitstream BS_{IMG} into an output image IMG′. For example, the bitstream BS_{IMG} may be generated from the image encoder 100 shown in FIG. 1. Hence, the output image IMG′ generated at the image decoder 1100 is a decoded image corresponding to the source image IMG encoded at the image encoder 100. The image decoder 1100 includes a decompression circuit 1102 and a reconstruction buffer 1104. The decompression circuit 1102 includes an entropy decoding circuit 1106 and a processing circuit 1108, where the processing circuit 1108 is configured to perform several decoding functions, including prediction, inverse quantization, reconstruction, etc. The output image IMG′ may be formed by a plurality of slices, wherein each of the slices may be independently decoded. In addition, each of the slices may have a plurality of coding blocks (or called coding units) each having a plurality of pixels. Each coding block (coding unit) is a basic decompression unit. For example, each coding block (coding unit) may have 8×2 pixels according to VESA A-DSC.

The bitstream BS_{IMG} includes entropy encoded control information (e.g., mode syntax, flatness syntax, and color domain syntax) and entropy encoded residual data (e.g., quantized residuals) of each coding block. The entropy decoding circuit 1106 may receive the entropy encoded control information and entropy encoded residual data of a coding block from a bitstream buffer (not shown). The entropy decoding circuit 1106 derives the control information (e.g., mode syntax, flatness syntax, and color domain syntax) from entropy decoding the bitstream BS_{IMG}. For example, the derived mode syntax may indicate that the current coding block is encoded using an MPP mode (or an MPPF mode) at an image encoder (e.g., image encoder 100), and the derived color domain syntax may indicate that the current coding block is encoded in a particular color space (e.g., RGB color space or YCoCg color space).

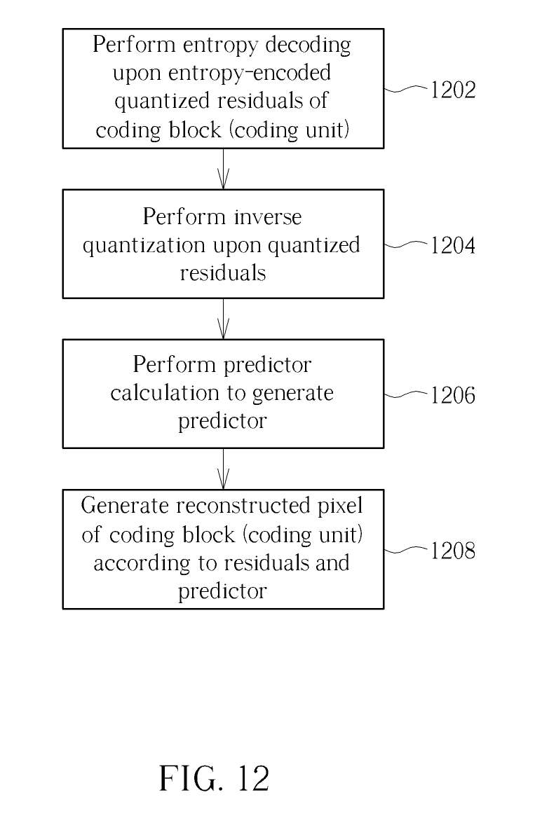

FIG. 12 is a flowchart illustrating an MPP-mode/MPPF-mode decoding procedure according to an embodiment of the present invention. At step 1202, the entropy decoding circuit 1106 derives the residual data (e.g., quantized residuals) of the current coding block from entropy decoding the bitstream BS_{IMG}. At step 1204, the processing circuit 1108 performs inverse quantization upon the quantized residuals to generate inverse quantized residuals of the current coding block. It should be noted that the MPP-mode inverse quantization may be different from the MPPF-mode inverse quantization. When the derived mode syntax indicates that the current coding block is encoded using an MPP mode (or an MPPF mode), a predictor is calculated by the processing circuit 1108 (Step 1206). After the predictor is obtained, reconstructed/decoded pixels of the current coding block can be generated by the processing circuit 1108 (Step 1208). For example, the processing circuit 1108 adds the predictor to each inverse quantized residual of the current coding block to obtain a corresponding reconstructed/decoded pixel of the current coding block (e.g., reconstructed pixel_{8×2}=inverse quantized residual_{8×2}+predictor).

The reconstruction buffer 1104 is configured to store reconstructed pixels of the output image IMG′. For example, when the current coding block is decoded using the MPP/MPPF mode, neighboring reconstructed pixels of the current coding block to be decoded may be read from the reconstruction buffer 1104 and then used for computing the predictor needed by the MPP/MPPF mode.

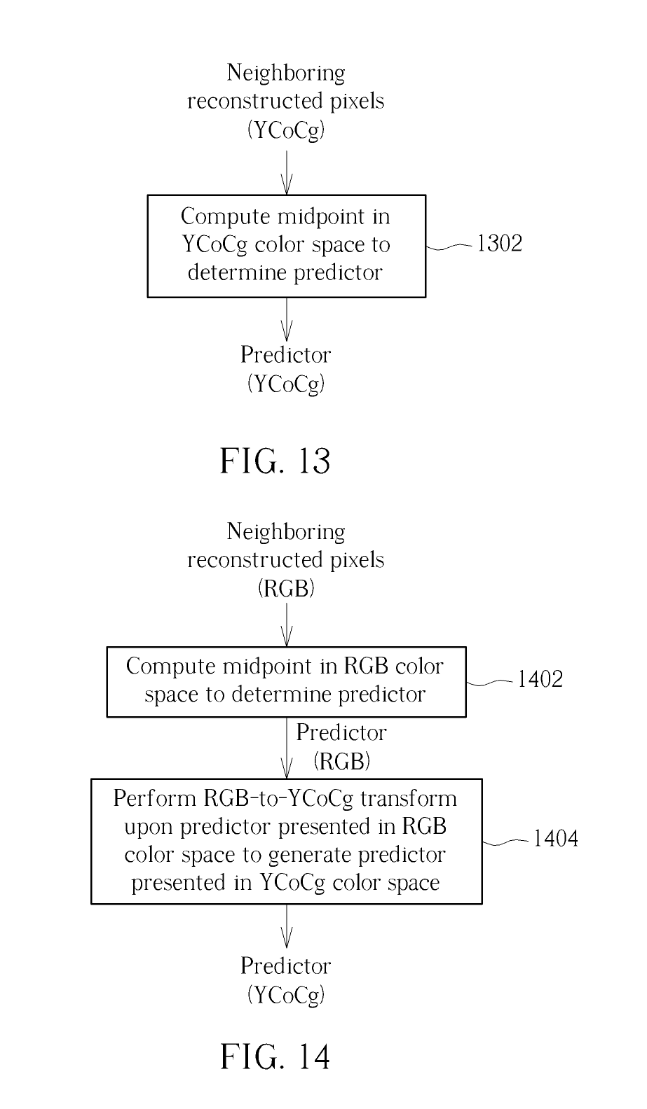

The aforementioned predictor computation scheme used by the image encoder 100 may also be employed by the image decoder 1100. FIG. 13 is a flowchart illustrating a first predictor computation scheme employed by the processing circuit 1108 of the image decoder 1100 according to an embodiment of the present invention. In a case where the current coding block BK_{CUR} (which is represented by an un-shaded area) is a non-first-row block as illustrated in FIG. 3, the neighboring reconstructed pixels needed for prediction computation are located at the previous pixel line L_{PRE} (which is represented by a shaded area). The neighboring reconstructed pixels may be presented in the RGB color space, while the derived coding mode may indicate that the current coding block is encoded in the YCoCg color space. Hence, the neighboring reconstructed pixels located at the previous pixel line L_{PRE} are transformed from the RGB color space to the YCoCg color space, and a predictor presented in the YCoCg color space can be computed based on the color-transformed neighboring reconstructed pixels located at the previous pixel line L_{PRE}.

Alternatively, in another case where the current coding block BK_{CUR} (which is represented by an un-shaded area) is a non-first-column block as illustrated in FIG. 4, the neighboring reconstructed pixels needed for predictor computation are located at the previous coding block BK_{PRE} (which is represented by a shaded area). The neighboring reconstructed pixels may be presented in the RGB color space, while the derived coding mode may indicate that the current coding block is encoded in the YCoCg color space. Hence, the neighboring reconstructed pixels located at the previous coding block BK_{PRE} are transformed from the RGB color space to the YCoCg color space, and a predictor presented in the YCoCg color space can be computed based on the color-transformed neighboring reconstructed pixels located at the previous coding block BK_{PRE}. An example of computing a predictor presented in the YCoCg color space based on reconstructed pixels presented in the RGB color space is illustrated in FIG. 6.

However, if the current coding block BK_{CUR} is the first-raw block (or first-column block) of the output image IMG′, this means reconstructed pixels at the previous pixel line L_{PRE} (or previous coding block BK_{PRE}) do not exist. Hence, a half value of the dynamic range of pixels presented in the YCoCg color domain is directly used as a predictor of the current coding block BK_{CUR}.

In above example, it is assumed that the neighboring reconstructed pixels are originally presented in the RGB color space, and the derived coding mode indicates that the current coding block is encoded using MPP/MPPF mode in the YCoCg color space. Hence, the neighboring reconstructed pixels processed by step 1302 are color-transformed reconstructed pixels generated from applying RGB-to-YCoCg transform to reconstructed pixels presented in the RGB color space. If the current coding block has 8×2 pixels, the computational complexity of one predictor presented in YCoCg color space may include 16 color transform operations and one mean calculation. However, this is not meant to be a limitation of the present invention. Alternatively, the neighboring reconstructed pixels may be originally presented in the YCoCg color space, and the derived coding mode may indicate that the current coding block is encoded using MPP/MPPF mode in the RGB color space. Hence, step 1302 may be modified to compute a predictor presented in the RGB color space by processing color-transformed reconstructed pixels generated from applying YCoCg-to-RGB transform to reconstructed pixels presented in the YCoCg color space. If the current coding block has 8×2 pixels, the computational complexity of one predictor presented in RGB color space may include 16 color transform operations and one mean calculation.

To reduce the computational complexity of one predictor presented in a desired color space, the present invention therefore proposes a new predictor computation scheme which applying color space transform to a first predictor presented in a first color space to generate a second predictor presented in a second color space different from the first color space.

In one exemplary design, the predictor presented in the first color space may be composed of mean values. Hence, the color-transformed predictor presented in the second color space is composed of color-transformed mean values, and may be directly used as a final predictor for decoding a coding block. Alternatively, the color-transformed predictor presented in the second color space may be an initial predictor. A processing function (e.g., clipping, rounding, and/or adding a value that may be calculated according to QP) may be performed upon color-transformed mean values of the initial predictor to generate processed color-transformed mean values (e.g., clipped/rounded/value-added color-transformed mean values) as predictor values of a final predictor used for decoding a coding block.

In another exemplary design, the predictor presented in the first color space may be composed of processed mean values (e.g., clipped/rounded/value-added mean values). Hence, the color-transformed predictor presented in the second color space is composed of color-transformed processed mean values (e.g., color-transformed clipped/rounded/value-added mean values), and may be directly used as a final predictor for decoding a coding block.

In summary, no matter whether a predictor to be transformed from a first color space to a second color space is composed of mean values or is composed of processed mean values (e.g., clipped/rounded/value-added mean values), using a color-transformed predictor to indirectly/directly set a final predictor used for decoding a coding block in the second color space would fall within the scope of the present invention.

FIG. 14 is a flowchart illustrating a second predictor computation scheme employed by the processing circuit 1108 of the image decoder 1100 according to an embodiment of the present invention. In a case where the current coding block BK_{CUR} is a non-first-row block as illustrated in FIG. 3, the neighboring reconstructed pixels needed for prediction computation are located at the previous pixel line L_{PRE}. The neighboring reconstructed pixels may be presented in the RGB color space, while the derived coding mode may indicate that the current coding block is encoded in the YCoCg color space. Hence, the neighboring reconstructed pixels located at the previous pixel line L_{PRE} are used to compute a predictor presented in the RGB color space (Step 1402), and then the predictor presented in the RGB color space is transformed from the RGB color space to the YCoCg color space to generate a predictor presented in the YCoCg color space (Step 1404). In this case, the predictor presented in the RGB color space may be composed of means values or may be composed of processed mean values (e.g., clipped/rounded/value-added means values), depending upon actual design considerations. In addition, a final predictor used for decoding a coding block in the YCoCg color space may be directly set by the color-transformed predictor, or may be indirectly derived from applying a processing function (e.g., clipping, rounding, and/or adding a value that may be calculated according to QP) to the color-transformed predictor.

Alternatively, in another case where the current coding block BK_{CUR} is a non-first-column block as illustrated in FIG. 4, the neighboring reconstructed pixels needed for predictor computation are located at the previous coding block BK_{PRE}. The neighboring reconstructed pixels may be presented in the RGB color space, while the derived coding mode may indicate that the current coding block is encoded in the YCoCg color space. Hence, the neighboring reconstructed pixels located at the previous coding block BK_{PRE} are used to compute a predictor presented in the RGB color space (Step 1402), and then the predictor presented in the RGB color space is transformed from the RGB color space to the YCoCg color space to generate a predictor presented in the YCoCg color space (Step 1404). In this case, the predictor presented in the RGB color space may be composed of means values or may be composed of processed mean values (e.g., clipped/rounded/value-added means values), depending upon actual design considerations. In addition, a final predictor used for decoding a coding block in the YCoCg color space may be directly set by the color-transformed predictor, or may be indirectly derived from applying a processing function (e.g., clipping, rounding, and/or adding a value that may be calculated according to QP) to the color-transformed predictor. An example of computing a predictor presented in the YCoCg color space based on reconstructed pixels presented in the RGB color space is illustrated in FIG. 9.

However, if the current coding block BK_{CUR} is the first-raw block (or first-column block) in the output image IMG′, this means reconstructed pixels at the previous pixel line L_{PRE} (or previous coding block BK_{PRE}) do not exist. Hence, a half value of the dynamic range of pixels presented in the YCoCg color domain is directly used as a predictor of the current coding block BK_{CUR}.

In above example, it is assumed that the neighboring reconstructed pixels are originally presented in the RGB color space, and the derived coding mode indicates that the current coding block is encoded using MPP/MPPF mode in the YCoCg color space. Hence, a predictor presented in the RGB color space is transformed to the YCoCg color space to generate a predictor presented in the YCoCg color space. The computational complexity of one predictor presented in YCoCg color space may include one mean calculation and one color transform operation. However, this is not meant to be a limitation of the present invention. Alternatively, the neighboring reconstructed pixels may be originally presented in the YCoCg color space, and the derived coding mode may indicate that the current coding block is encoded using MPP/MPPF mode in the RGB color space. Hence, step 1402 may be modified to compute a predictor presented in the YCoCg color space and then transform the predictor presented in the YCoCg color space to a predictor presented in the RGB color space. The computational complexity of one predictor presented in RGB color space may include one mean calculation and one color transform operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image encoding method for encoding an image, comprising:
determining a coding mode selected from a plurality of candidate coding modes for a current coding block, wherein the current coding block included in the image comprises a plurality of pixels; and
encoding the current coding block into a part of a bitstream according to at least the determined coding mode, comprising:
determining a first predictor presented in a first color space according to a plurality of reconstructed pixels presented in the first color space;
transforming the first predictor presented in the first color space to a second predictor presented in a second color space, wherein the second color space is different from the first color space; and
encoding the current coding block under the second color space according to at least the second predictor.

2. The image encoding method of claim 1, wherein determining the first predictor presented in the first color space according to the reconstructed pixels presented in the first color space comprises:
calculating a mean value of each color channel of the reconstructed pixels; and
generating the first predictor according to a plurality of mean values of a plurality of color channels of the reconstructed pixels.

3. The image encoding method of claim 1, wherein:
the reconstructed pixels are generated from reconstructing a plurality of pixels of a previous coding block, where the previous coding block is a left coding block of the current coding block; or
the reconstructed pixels are generated from reconstructing a plurality of pixels located at a previous pixel line, where the previous pixel line is directly above an upper-most pixel line of the current coding block.

4. The image encoding method of claim 1, wherein one of the first color space and the second color space is an RGB color space, and another of the first color space and the second color space is a YCoCg color space.

5. The image encoding method of claim 1, wherein the determined coding mode is a Video Electronics Standards Association (VESA) Advanced Display Stream Compression (A-DSC) midpoint prediction (MPP) mode or a VESA A-DSC midpoint prediction fallback (MPPF) mode.

6. An image decoding method for decoding a bitstream generated from encoding an image, comprising:
deriving a second color space and a coding mode used for encoding a current coding block in the image from the bitstream, wherein the current coding block included in the image comprises a plurality of pixels; and
decoding the current coding block into a part of a decoded image according to at least the derived coding mode, comprising:
determining a first predictor presented in a first color space according to a plurality of reconstructed pixels presented in the first color space, wherein the first color space is different from the second color space;
transforming the first predictor presented in the first color space to a second predictor presented in the second color space; and
decoding the current coding block under the second color space according to at least the second predictor.

7. The image decoding method of claim 6, wherein determining the first predictor presented in the first color space according to the reconstructed pixels presented in the first color space comprises:
calculating a mean value of each color channel of the reconstructed pixels; and
generating the first predictor according to a plurality of mean values of a plurality of color channels of the reconstructed pixels.

8. The image decoding method of claim 6, wherein:
the reconstructed pixels are generated from reconstructing a plurality of pixels of a previous coding block, where the previous coding block is a left coding block of the current coding block; or
the reconstructed pixels are generated from reconstructing a plurality of pixels located at a previous pixel line, where the previous pixel line is directly above an upper-most pixel line of the current coding block.

9. The image decoding method of claim 6, wherein one of the first color space and the second color space is an RGB color space, and another of the first color space and the second color space is a YCoCg color space.

10. The image decoding method of claim 6, wherein the derived coding mode is a Video Electronics Standards Association (VESA) Advanced Display Stream Compression (A-DSC) midpoint prediction (MPP) mode or a VESA A-DSC midpoint prediction fallback (MPPF) mode.

11. An image encoder for encoding an image, comprising:
a mode decision circuit, configured to determine a coding mode selected from a plurality of candidate coding modes for a current coding block, wherein the current coding block included in the image comprises a plurality of pixels; and
a compression circuit, configured to encode the current coding block into a part of a bitstream according to at least the determined coding mode, wherein the compression circuit determines a first predictor presented in a first color space according to a plurality of reconstructed pixels presented in the first color space, transforms the first predictor presented in the first color space to a second predictor presented in a second color space, and encodes the current coding block under the second color space according to at least the second predictor, where the second color space is different from the first color space.

12. The image encoder of claim 11, wherein the compression circuit calculates a mean value of each color channel of the reconstructed pixels, and generates the first predictor according to a plurality of mean values of a plurality of color channels of the reconstructed pixels.

13. The image encoder of claim 11, wherein:
the reconstructed pixels are generated from reconstructing a plurality of pixels of a previous coding block, where the previous coding block is a left coding block of the current coding block; or
the reconstructed pixels are generated from reconstructing a plurality of pixels located at a previous pixel line, where the previous pixel line is directly above an upper-most pixel line of the current coding block.

14. The image encoder of claim 11, wherein one of the first color space and the second color space is an RGB color space, and another of the first color space and the second color space is a YCoCg color space.

15. The image encoder of claim 11, wherein the determined coding mode is a Video Electronics Standards Association (VESA) Advanced Display Stream Compression (A-DSC) midpoint prediction (MPP) mode or a VESA A-DSC midpoint prediction fallback (MPPF) mode.

16. An image decoder for decoding a bitstream generated from encoding an image, comprising:
an entropy decoding circuit, configured to derive a second color space and a coding mode used for encoding a current coding block in the image from the bitstream, wherein the current coding block included in the image comprises a plurality of pixels; and
a processing circuit, configured to decode the current coding block into a part of a decoded image according to at least the derived coding mode, wherein the processing circuit determines a first predictor presented in a first color space according to a plurality of reconstructed pixels presented in the first color space, transforms the first predictor presented in the first color space to a second predictor presented in the second color space, and decodes the current coding block under the second color space according to at least the second predictor, where the first color space is different from the second color space.

17. The image decoder of claim 16, wherein the processing circuit calculates a mean value of each color channel of the reconstructed pixels, and generates the first predictor according to a plurality of mean values of a plurality of color channels of the reconstructed pixels.

18. The image decoder of claim 16, wherein:
the reconstructed pixels are generated from reconstructing a plurality of pixels of a previous coding block, where the previous coding block is a left coding block of the current coding block; or
the reconstructed pixels are generated from reconstructing a plurality of pixels located at a previous pixel line, where the previous pixel line is directly above an upper-most pixel line of the current coding block.

19. The image decoder of claim 16, wherein one of the first color space and the second color space is an RGB color space, and another of the first color space and the second color space is a YCoCg color space.

20. The image decoder of claim 16, wherein the derived coding mode is a Video Electronics Standards Association (VESA) Advanced Display Stream Compression (A-DSC) midpoint prediction (MPP) mode or a VESA A-DSC midpoint prediction fallback (MPPF) mode.
